(19) United States
(12) Patent Application Publication
(10) Pub. No.: US 2004/0088177 A1
(43) Pub. Date: May 6, 2004

(54) Employee performance management method and system

(75) Inventors: Karma S. Travis, Plano, TX (US); Edward Thomas Eves III, Dallas, TX (US); Jay Russell Bourdette, Dallas, TX (US); Samantha A. Varjian, Plano, TX (US)

Correspondence Address: ELECTRONIC DATA SYSTEMS CORPORATION, 5400 LEGACY DR., M/S H3-3A-05, PLANO, TX, 75024, US

(73) Assignee: Electronic Data Systems Corporation

(21) Appl. No.: 10/287,147

(22) Filed: Nov. 4, 2002

(51) Int. Cl. G06F 17/60

(52) U.S. Cl. 705/1; 705/11

(57) ABSTRACT

A performance management system for identifying, differentiating, and rewarding performance of an employee, comprising: means for communicating performance status to the employee; means for communicating to the employee differences between the communicated performance status and a performance standard associated with the employee; and means for developing a prescriptive path for the employee to adjust the communicated performance status in response to said performance standard.

### TECHNICAL FIELD OF INVENTION

This invention, in general, relates to a system and method for managing employee performance. More specifically, this invention relates to an employee performance management method and system for the measuring, differentiating, planning, and overall managing of employee performance within a company or organization.

### BACKGROUND OF THE INVENTION

In the highly competitive business market of today, businesses require employees of the highest caliber. To be competitive, there is the need to constantly raise the bar on performance. To achieve these objectives, companies need to be able to fairly evaluate employee performance in an objective unbiased way. At the same time, not to tell an employee the truth about his or her relative performance deprives the employee of knowledge necessary for performance improvement.

Businesses often employ performance appraisals as an integral part of management training and promotion programs. Typically, an appraisal includes a questionnaire or other type of survey device for eliciting responses from the manager to be evaluated and from selected co-workers. The survey may include a series of questions for obtaining responses suitable for developing data respecting the strength or weakness of the employee, in relation to the employee's duties, and how others perceive the employee's performance. Frequently, the leader may compile response data for later review by the employee.

One problem with today's employee evaluation tools relates to the large number of different programs that companies may use in different locations throughout their many offices. There is no consolidated system providing the ability to take information from a variety of legacy computer systems and human resource database programs that have large numbers of employee records. Moreover, existing systems are written in common data base languages, preventing, their easy use throughout the organization. This may cause communications to be disjointed and not susceptible to a cohesive management or control.

Still another problem with known programs for assisting with employee records has to do with their not being able to link easily with existing employee record systems. Many companies use different types of employee directories, each including significant amounts of information relating to individual employees. However, no known program can retrieve the data to populate an employee performance appraisal and management program with records from existing human resource databases personnel directories.

In organizations having thousands of employees across many countries and a number of continents, no known employee performance appraisal and management system can particularly be useful on a company-wide basis. Employees move to and from different company facilities, but neither their managers nor the employees themselves have a reliable way to track, record, report, and/or manage their progress in working for the company.

### SUMMARY OF THE INVENTION

In accordance with the present invention, an employee performance management method and system are provided that substantially eliminate or reduce the disadvantages and problems associated with prior employee appraisal and performance management systems and processes.

Accordingly, the present invention provides a performance management method and system for evaluating, planning, and reviewing employee performance. The system, including flexible tools for assessing and grouping, includes means for evaluating performance of employee. For the method and system further include steps for planning the employee performance. The system and method of the present invention further includes means for reviewing employee performance for ensuring optimal achievement relative to stated performance objectives.

The present invention bridges the alignment of organizational goals to individual performance evaluations. Reviewing progress towards employee's objectives is the first step in creating an individual development plan for an employee in the career planning process. This defines the objectives that an employee may work towards for the next performance cycle. If an employee wants to improve his performance, the present invention helps coach the employee on what his individual needs may be to better his grouping level for the next performance cycle.

A technical advantage of the present invention includes the ability to provide employee performance measurement, differentiation planning, interfaces to different company database systems for improving the evaluation and improvement of employee performance. Moreover, the project invention makes optimal use of company databases and related resources.

While employee performance may range widely, managers can best serve employees by coaching them for performance improvement. By guiding employees on steps to improve, the present invention ensures that employees know what skills or actions to take to raise employment potential and job opportunities. The manager may complete an individual development plan with his employees if the employee asks for your coaching on how to fill one out or if you feel the employee could benefit.

The present invention supports the important goals of helping the company and its lenders to: (1) demonstrate integrity in all actions, decisions, and words; (2) value and respect every individual; (3) attract, develop, and retain the most outstanding employees; (4) base rewards on performance; (5) promote open, honest, and candid communication and actively facilitate the flow of information and learning; and (6) operate as a collective community.

The employee performance management method and system of the present invention provides a foundation to identify, differentiate, and reward employee performance. Through a consistent process, the present invention lets employees know where they stand, understand what is expected of them, and create a plan to grow and develop their skills. Leaders may use the system and process of the present invention to provide ongoing, meaningful conversations with their employees, improve productivity and align rewards to performance. This results in an ongoing, two-way communication process between leaders and their employees to facilitate improved performance and communication, organizational alignment and capability, and increased employee self-management.

This capability and flexibility makes the present invention useful as a standard system in a multi-lingual company. Also these features make the present invention useful for employees who may move to different offices in different countries, but within the company.

A technical advantage of the present invention includes its ability to give employees an opportunity to participate in the management of their performance. From providing input on objectives to initiating performance progress meetings, the present method and system support a focus on individual ownership and responsibility for performance.

A further technical advantage includes facilitating active coaching and providing timely feedback are also technical advantages of the present invention. The present invention supports effective coaching and constructive, prompt feedback to help employees and managers accomplish business goals and achieve continuous improvement.

Furthermore, the present invention includes the technical advantage of fostering an environment of open dialogue based on mutual trust and respect. Employee involvement is essential, is a collaborative program that involves input and feedback from both individual employees and leaders. The present method and system help to advocate a positive, collaborative approach for improving performance and accomplishing business goals.

Other technical advantages are readily apparent to one skilled in the art from the following figures, description, and claims.

### BRIEF DESCRIPTION OF THE DRAWINGS

For a more complete understanding of the present invention and advantages thereof, reference is now made to the following description taken in conjunction with the accompanying drawings in which like reference numbers indicate like features and wherein:

FIG. 1 shows the concepts of the present invention for evaluating, planning, and reviewing employee performance;

FIG. 2 presents the initial user interface for use of the preferred embodiment of the present invention;

FIG. 3 shows the user interface serving as an entry point for the system of the present invention;

FIG. 4 depicts the screen to which the present invention directs the user for creating and transferring employee performance assessments;

FIG. 5 presents one manner in which the present invention permits the user to use employee performance assessments from prior periods;

FIG. 5A shows the process of requesting and retrieving employee data from a corporate directory service according to the teachings of the present invention;

FIG. 6 illustrates numerous aspects of preparing employee performance records and populating employee performance files consistent with the teachings of the present invention;

FIG. 7 exhibits the ability of the present embodiment to create multiple employee performance assessments;

FIG. 8 shows how the present embodiment permits the designation of multiple assessments for creation;

FIG. 9 represents how the present invention may display the status of multiple assessments respecting different employees;

FIG. 10 renders one view of the importance weighting and scoring functions of the present invention as relating to specified shared competencies of a given employee;

FIG. 11 gives a screen interface for employee performance assessment relating to job specific skills as provided by the present invention;

FIG. 12 shows how the present embodiment permits reporting on supplemental skills that an employee may possess as related to their performance assessment;

FIG. 13 displays the flow process for the development of grouped performance assignments of the present invention;

FIG. 14 provides a listing of grouped assessments as they might appear to a user of the present invention;

FIG. 15 further illustrates the template-driven tool of the present invention for making employee performance assessment groupings;

FIG. 16 depicts how the present invention permits the stating of objectives relating to employee performance;

FIG. 17 details how the present invention permits development of business and learning objectives;

FIG. 18 exhibits further the aspect of the present embodiment for assessing employee performance strengths and needs, as well as providing a summary of the employee performance assessment;

FIG. 19 shows the capability of the preferred embodiment for generating reports of employee performance;

FIG. 20 shows the different selections for employee performance assessment reports as provided by the present embodiment;

FIG. 21 gives one view of the present invention's ability to save different templates of employee performance assessments for future use;

FIG. 22 shows the multiple assessment transfer features of the present invention;

FIGS. 23 through 25 illustrate the further feature of the present invention for managing peer-team-customer employee performance assessments;

FIG. 26 displays the quarterly tracking template for one embodiment of the present invention;

FIG. 27 depicts further aspects of surrogate designation with the present embodiment of the invention;

FIG. 28 illustrates the job search aspects of the present embodiment; and

FIG. 29 provides a table outlining the steps to be completed during a typical calendar year to implement the improved employee performance management system and process of the present invention.

### DETAILED DESCRIPTION OF PREFERRED EMBODIMENT

The preferred embodiments of the present invention and its advantages are best understood by referring to the drawings, in which like numerals refer to like parts throughout the several views. Those skilled in the art will understand that the employee performance management system and process of the present invention may also be used to measure the effectiveness of employees or other individuals in a variety of situations. These situations may include, for example, companies, non-profit entities, and other organizations where their performance over a period of time may be managed.

The present invention provides a process and system that is flexible and systematic for managing employee performance. The method system permit leaders to break company strategy down into component parts (goals and key job responsibilities) that make sense for employees and that relate directly to their roles in the company. The present invention, in preferred embodiment, helps to establish clear expectations for employees and provide to them direction and a supporting structure for achieving performance objectives. The present invention, moreover, provides a practical way for leaders to help employees achieve their objectives and to effectively align their activities to achieve company goals and a manner consistent with company strategy.

Leaders can help break overall business strategy down into “manageable chunks” that make sense for the employees' different roles in the organization. Using the present inventions, the employee and his leader may develop and/or clarify organizational goals, team goals, key job responsibilities for individual positions, and individual objectives.

FIG. 1, therefore, illustrates a number of the basic concepts of the employee performance management process 10 of the present invention. In essence, employee performance management process 10 includes evaluation phase 12, which serves, through developmental steps 14, as the basis for planning phase 16. Evaluation phase 12 involves the steps of performing employee assessments, grouping employees consistent with the assessments, and measuring prior performance against prior plans, if any have been established. Planning phase 16 entails establishing, through the system of the present invention, both business objectives and learning objectives reflective of development steps 14.

In response to planning phase 16, employees and leaders act through various steps 18 of employee performance management process 10 until review phase 20. Review phase 20 employs the system and steps of the present invention for providing employee feedback, coaching discussions from leaders to employees, as well as generating for the employees important progress and status information and reports. From review process 20, both employees and leaders develop the ability to undergo improvement steps 22 leading to evaluations for continually employee performance.

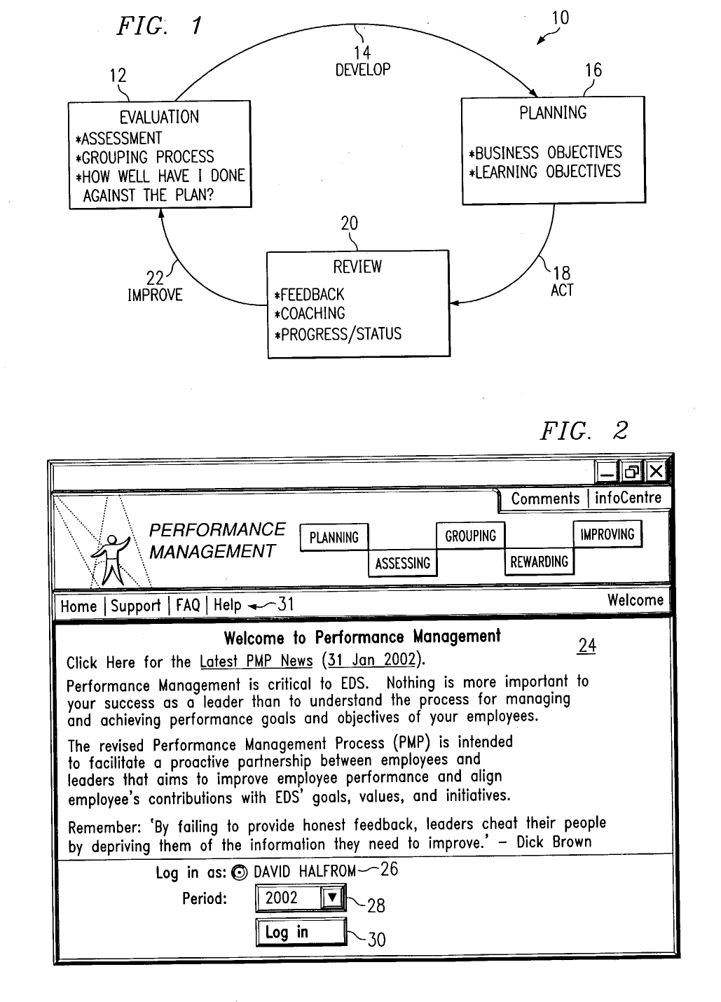

The present embodiment of the invention provides a highly integrated on-line tool for supporting employee performance management process 10. One skilled in the art will understand many of the necessary programming tasks necessary to implement the different steps comprising the employee performance management process 10. Moreover, much of the computer programming to implement the various features of the present invention may take various forms. What is particularly important respecting the present invention, however, is the highly integrated way of supporting the employee performance management processes that FIG. 2 depicts.

FIG. 2 shows one possible embodiment of a Home screen 24, which allows a user to access the employee performance management system of the preferred embodiment (herein referred to as the performance management program or PMP). Home screen 24 also displays the user's name and any others for whom the user is a surrogate at “Log in as” space 26. Note that here the user selects whom to log in as, i.e., as the user himself or as a surrogate for another person. The user then chooses a period at “Period” dropdown menu 28 before clicking the “Log in” button 30. Default choices are for self at “Log in as” space 26 and the current period at “Period” dropdown menu 28. To view data from another period or calendar year, the user will log out, select the period, and then log back in to see data from that period. This can be done by clicking on “Home” line 31 in the menu bar via a Home screen 24.

After passing through standard authentication, the PMP preferably determines whether the user is already in the database as a leader from a previous period. If a record exists, the rights stored there will be used to determine the user's security level. If no record exists in the data store, the application may query the corporate directory to determine whether the user is listed with a leader job code. If the user has a leader job code, he may be authorized as an assessing manager and, as a result, will receive access to the performance management process tool.

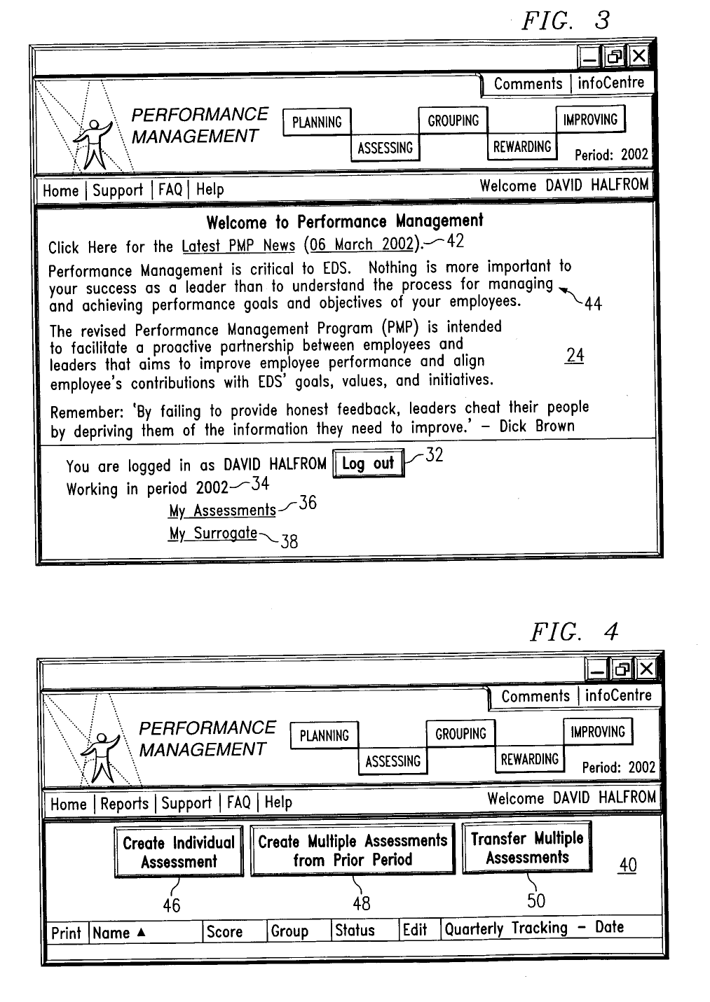

FIG. 3 shows the one embodiment of a user interface serving as a entry point for using the system of the present invention, in which the user, in this case “DAVID HALFROM,” is identified at user space 32 and indicating in period space 34 the period of review is the year “2002.” Below this information, by selecting “My Assessments” hyperlink 36, the user goes to Assessments Screen 40 (FIG. 4) and now may select from a further number of options. In FIG. 3, the PMP provides additional information, including the ability, as shown by “News” hyperlink 42, to view the latest PMP news, as well as to view additional information, such as information 44, respecting the operation of the performance management program of the present invention.

Assessments Screen 40 displays “My Assessments” hyperlink 36, a “My Templates” hyperlink (if any have been created or sent to the user, though hyperlink not here shown, and “My Surrogate” hyperlink 38, as well as performance period 34, here “2002”. By clicking on “My Assessments” hyperlink 36, the user the assessments which have been created, or to create new assessments. Clicking on a “My Templates” hyperlink permits viewing, deleting, or sending existing templates. Clicking on “My Surrogate” hyperlink 38 permits adding, changing, or deleting a surrogate for the user.

FIG. 4 depicts Assessments Screen 40 to which the present invention directs the user for creating and transferring employee performance assessments after having selected the “My Assessments” hyperlink 36 of Home screen 24. Assessments Screen 40 permits the user to select further to “Create Individual Assessment” as button 46 indicates, “Create Multiple Assessments,” as button 48 indicates, and to “Transfer Multiple Assessments” as button 50 depicts.

The present embodiment of the PMP creates single assessments in three different ways, although the present invention contemplates that other ways of providing such assessments are well within the scope of the invention. An assessment, for example, may be created by (1) entering all new information using “Create Individual Assessment” button 46; (2) by populating some of the information from a template using “Create Multiple Assessment from Prior Period” button 48, or, as a further example, (3) by populating some of the information from the employee's prior period assessment if it was created by the current leader using “Transfer Multiple Assessments” button 50. In the present embodiment, new assessments can be created for the current period, but not for prior periods.

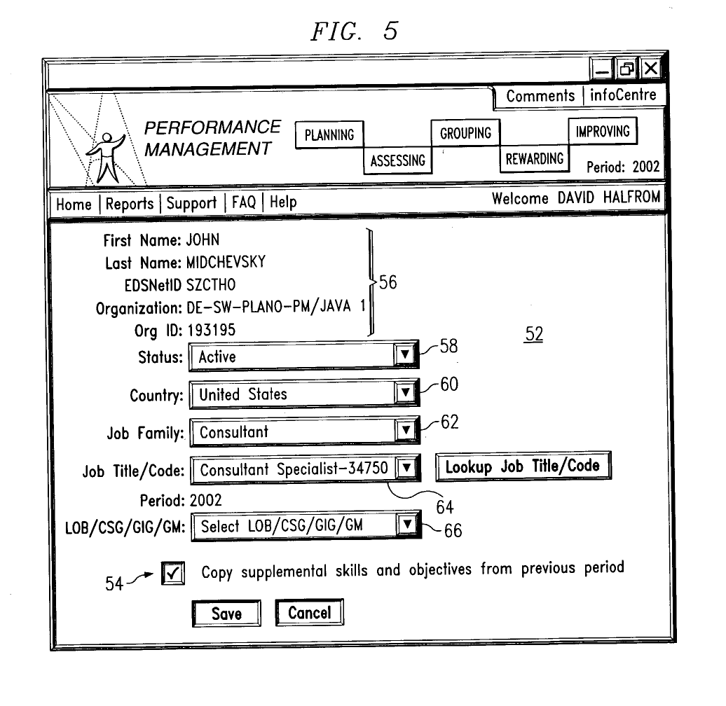

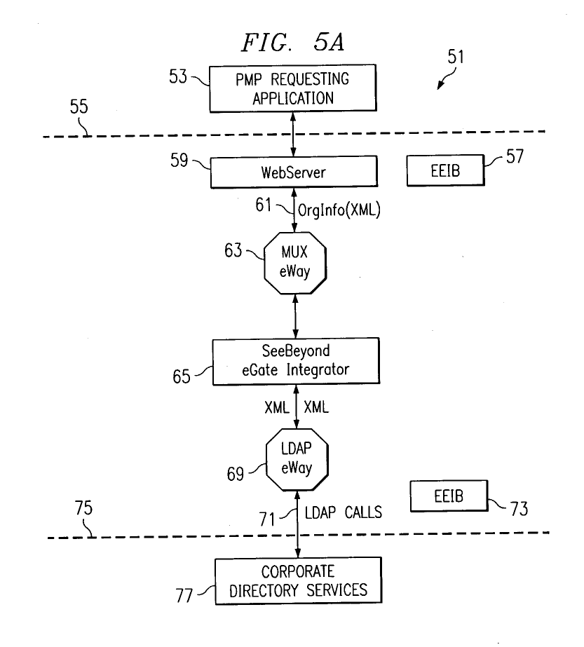

FIG. 5 presents one exemplary manner in which the PMP permits the user to make use of employee performance assessments from prior periods. The PMP takes the user to Assessment Creation screen 52 upon selection of “Create Individual Assessments” button 46. Assessment Creation screen 52 may provide the ability, as space 54 indicates, to copy supplemental skills and objectives from a previous period for the individual identified in the identification information area 56. In addition, “Status” dropdown menu 58, “Country” dropdown menu 60, “Job Family” menu 62 and “Job Title/Code” menu 64 provide information for designating the particular employee about which the user will make an assessment. In addition, LOB/CSG/GIG/GM menu 66 may permit further identifying the individual and the organization to which the individual may be associated.

The user completes the employee's profile by entering data for the dialog fields 86, in the displayed embodiment. Use of Employee Status dropdown menu 58, in the shown example, denotes whether the employee is Active, New to Job, Leave of Absence Status or Separated. Use of the dropdown menus is to choose appropriate selections for Country 60, Job Family 62, and Job Title/Job Code 64. A separated employee in the present embodiment an employee who has been separated from the company in their respective HR System after an assessment has been created. This status allows the leader to track the employee's performance without including the employee in the grouping session.

For purposes of this exemplary embodiment, an active employee full-time may be a person on the company payroll. One way to use the present system, therefore, may be to ensure that all employees receive a performance assessment, but only that active employees be included in the performance grouping process. Job Titles/Codes and their Job Families can be searched for by clicking on the “Lookup Job Title/Code” button 68 of Assessments Creation screen 52, entering the beginning numbers of a Job Code, clicking the “Search” button 72, and then clicking on the correct Job Code from search results 74.

FIG. 5A illustrates one embodiment of the employee record retrieval process 51 of the PMP, particularly as relating to the logical architecture for retrieving employee data from a corporate directory service. In FIG. 5A, the retrieval process may begin at step 53 through the transmission of a request for data being directed to the corporate directory system into the corporate intranet layer 55 using an EEIB Java Servlet 57 through a PMP request browser or web server 59. The preferred embodiment, in response will format the data into an XML transaction request at step 61. Then, the process will send the XML request and associated date via an HTTPS URL for a Get/Post transport function. The company Web server will then catch the HTTPS request, routing it using an EEIB Java Servlet 57. EEIB Java Servlet uses, for example, a SeeBeyond JAVA MUX eWay 63 facility to connect and ‘publish’ request (People/Org Info). The XML function will describe the message and data structure of each unique request (i.e. PersonInfo, OrgInfo).

The rules associated with the SeeBeyond Transform/ Translate the data to a Receiving Apps format at SeeBeyond eGate Integrator 65. Thereafter, the LDAP eway will ‘subscribe’ to the People Org Info request. This permits the LDAP eway 69 to connect and bind the process flow the Corporate Directory. A next step 71 is to call the Corporate Directory using another EEIB Java Servlet 73 with LDAP calls provided by LDAP eWay to enter layer 75 and access Corporate Directory Services application 77. In response to which the Corporate Directory Services 77 performs an API request.

Responding to the API request, the Corporate Directory Services 77 API will publish result data and then transform/translate the result into XML structure using EEIB Java Servlet 75. The process continues with a subscription to the Corporate Directory result by the PMP, which then receives the result data. This causes the PMP to possess the associated employee data displaying, for example, in Assessment Creation Screen 52 of FIG. 5.

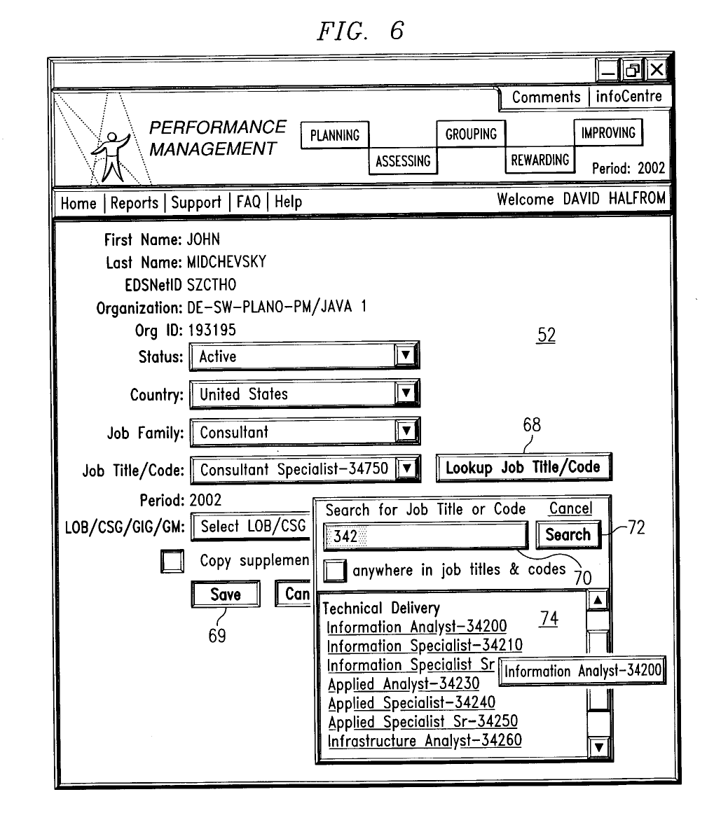

FIG. 6 further illustrates an example of Assessment Creation screen 52 to demonstrate numerous aspects of preparing employee performance records and populating employee performance files consistent with the teachings of the present invention. Assessment Creation screen 52 depicts “Lookup Job Title/Code” 68 whereby the user may provide a job title or code in dropdown menu 70. Through search function 72, the “Lookup Job Title/Code” function provides the ability to identify different job titles 74 for further use.

If the user wants to create an assessment using an existing template, then the user may select the template from the information that search results window 74 provides. All job code information, objectives, and supplemental skills will be set from the template.

The template function appearing in the example of Assessments Screen 52 may be used after the user has set the objectives for a specific employee. Each template is tied to a specific job code. To complete the creation of the assessment the user clicks the “Save” button. Where more than one employee in a team has the same job code and duties, the template function may be used to populate objectives and importance weights tied to that job code. After creation of the first assessment, it may be saved as a template.

FIG. 7 exhibits an instance of the present invention's ability of the present embodiment to create multiple employee performance assessments. Assessments Screen 40, as mentioned above in FIG. 4, illustrates the ability to create multiple assessments from prior period. Upon clicking on “Create Multiple Assessments from Prior Period” button 48, the user goes to Multiple Assessments Screen 76 that includes, for example, for a listing of multiple individuals 78 for which Multiple Assessments Screen 76 provides assessment status information. In addition, “create” selection boxes 80 permit selection whether an individual assessment is to be created for the individual. Clicking the “Create Multiple Assessments from Prior Period” button 48 reveals a list of assessments from the prior period. This allows the assessing manager to create assessments using the objectives and supplemental skills data from the previous period. The user can complete this by selecting the associated check box in “Create” check box list 80 next to the employee(s) name, then clicking the “Create Selected Assessments” button 84.

An assessing manager may create a current period assessment for an employee using data from the prior period when an assessment for that employee exists in a prior period. The new assessment could include the supplemental skills and objectives from the prior period. The shared competencies and job specific skills may also be created from the current application data, as for any new assessment.

To create multiple assessments using an existing template, the user selects the check box, activate a hyperlink, or take some other action relating to an active element next to the employee(s) name at “Create” check box listing 80 and select a template from the Template dropdown box using “Lookup Job Title/Code” button 68 (FIG. 6). A dropdown box, for example, will be displayed if a template exists in the current period. Then the user will click the “Create Selected Assessments” button 48.

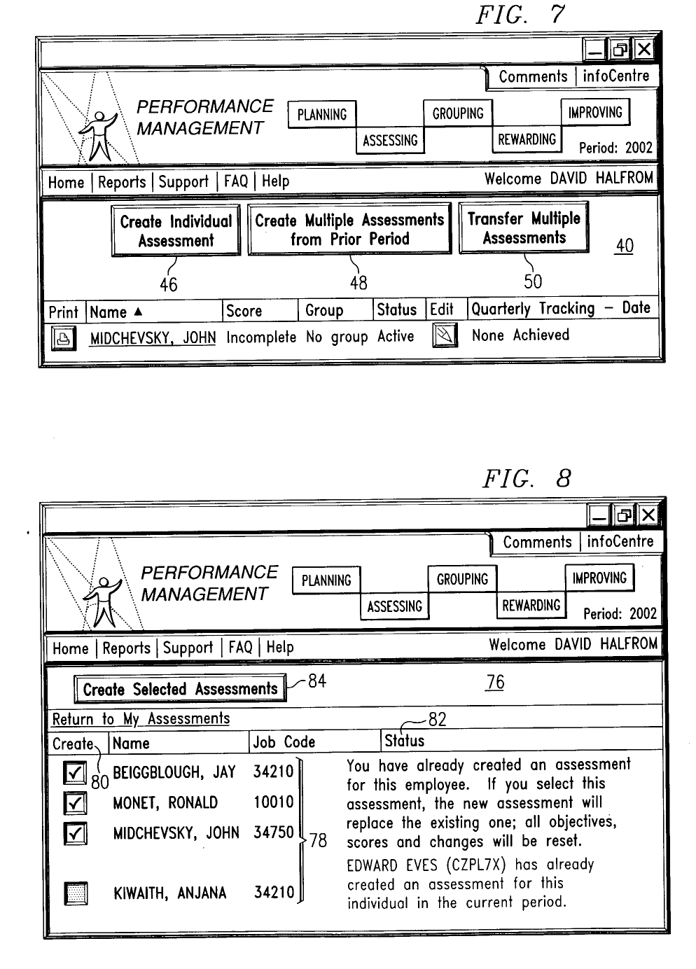

FIG. 8 shows how the present embodiment may permit the designation of multiple assessments for creation. For example, in FIG. 8, the names “BEIGGBLOUGH, JAY,” having job code 34 10, “MONET, RONALD,” having job code 10010, and “MIDCHEVSKY, JOHN,” having job code 34750, have been designated with the checkmarks in “create” check box listing 80 that an assessment will be made. However, for “KIWAITH, ANJANA,” also having job code 34210, create window from “create” check box listing 80 has not been checked. This selection has been made in response to the status information in Status area 82 that indicates, for example, that for “MIDCHEVSKY, JOHN,” the user has already created an assessment for the employee.

Status listing 82 further indicates that if the user selects this assessment, the new assessment for “Midchevsky, John” will be replaced with the existing one and all objectives, scores and changes will be reset. With the preferred embodiment, only one assessment may be created for an employee in each period. This may be seen at create Assessments Screen 76, which lists at status listing 82 the prior period assessments messages to indicate that an assessment has already been created for the employee in the current period. Thus, as listing 82 shows, the following message will appear if the user has already created an assessment for an employee in the current period:

“You have already created an assessment for this employee. If you select this assessment, the new assessment will replace the existing one; all objectives, scores and changes will be reset.”

The following message will appear if another leader has already created an assessment for an employee in the current period:

“JONATHAN SWIFT (CZPL7X) has already created an assessment for this individual in the current period.”whose name has this message next to it, the user contacts the named leader. The named leader may either transfer the assessment that was already created to the user, or have the user delete the prior assessment to create a new one.

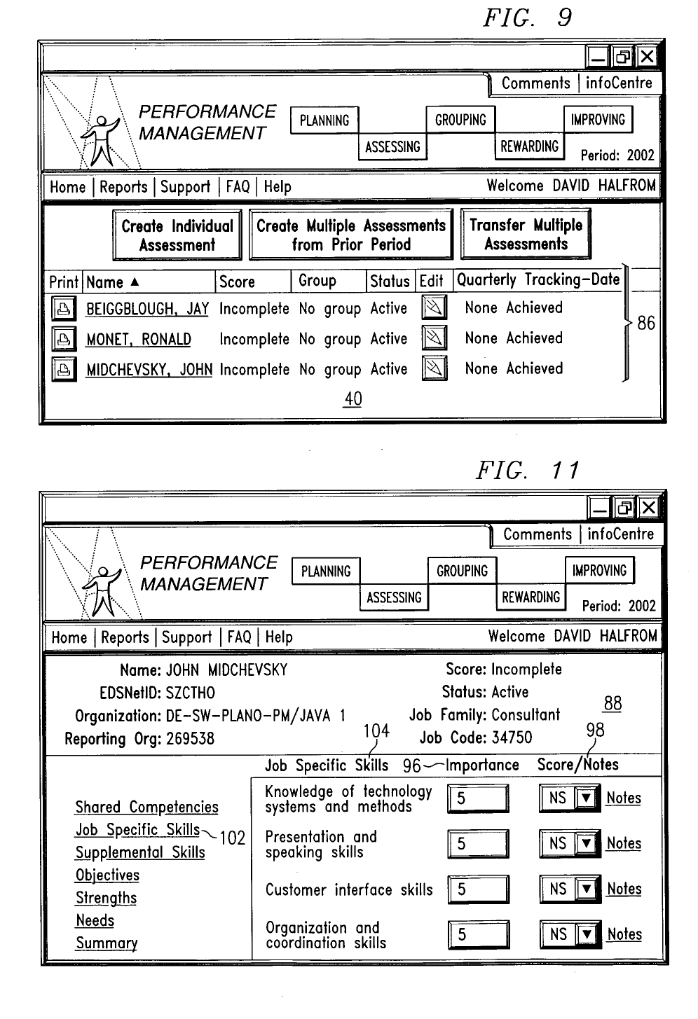

FIG. 9 represents how the present invention may display the status of multiple assessments respecting different employees. For example, the names “BEIQGBLOUGH, JAY,” having job code 34210, “MONET, RONALD,” having job code 10010, and “MIDCHEVSKY, JOHN,” having job code 34750, have been designated with the checkmarks in create windows 80 that an assessment will be made.

To begin assessing an employee, the user may click on their name on the Assessment List 86 of Assessments Screen 40. The employee profile will be displayed in the header throughout the assessment screens. Hypertext links on the left side of the screen provide the ability to move to all other screens. For example, to weight the job-specific skills, click on job specific skills, etc. The Employee Profile screen defaults to the Shared Competencies screen below the header. Moving the mouse over each shared competency will display characteristics attributed to that competency.

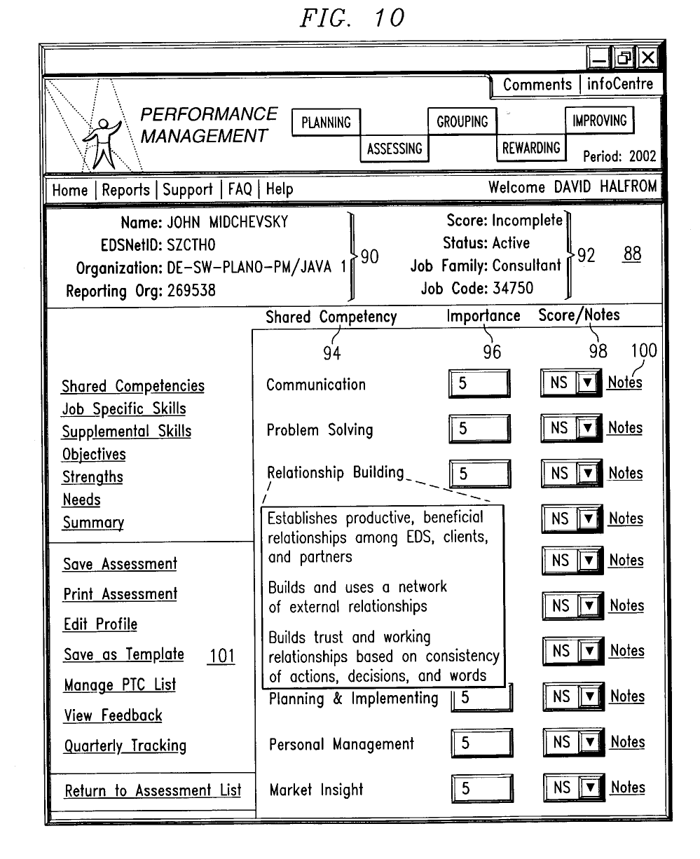

FIG. 10 renders one view of Individual assessment screen 88 to show how the present invention provides importance weighting and scoring functions. Individual assessment screen 88 provides employee personnel data in employee personnel data area 90 and assessment record data in individual assessment record area 92. Below these areas in individual assessment screen 88 appear shared competency listing 94, importance field listing 95, and score/notes dropdown menus 98. Notes hyperlink 100 associates with each score/notes dropdown menu 98. Importance region 96 of Individual Assessments Screen 88 permits the user to input importance weights to be associated with each shared competency. Moreover, in addition, Score/Notes dropdown menus 98 permit the user to provide for the individual assessment specific information relating to each particular shared competency as it relates to the individual. Through Notes hyperlinks 100, the user is permitted to provide specific notes relating to that individual and that particular shared competency.

In the example of Individual Assessments Screen 88 with regard to the shared competency of communication, an importance weight of five has been awarded to the individual shared competency to reflect the particular job code and the individual's position. Moreover, in this particular instance, no score is indicated by the “NS” value from the dropdown menu for the Score/Notes block.

The Importance Weights which Importance Weight fields 96 receives may serve as indicators to the employee of the priority of each shared competency, job specific skill, supplemental skill, and objective. The leader will assign to each a number that is the relative value of the skill in relation to the position the individual is performing. The weighting scale that the present embodiment employs ranges from 1 (low importance) to 10 (high importance). Scale of 1-10 used to determine the relative importance of the skill, competency or objective. Share competencies are skills common to all employees regardless of their job family or job code.

The present embodiment of the PMP derives a calculation derived from individual scores and importance weightings in the shared competencies, job specific skills, supplemental skills and objective sections for each assessed employee. The score maybe used as an initial reference point for grouping levels as described in detail below.

Once the importance weightings of each skill, competency, and objective have been entered, the user may begin scoring each item. During assessment, the user may evaluate how well the employee being assessed demonstrates the skill regardless of the importance assigned. In order to score each item, the user will reference the appropriate Score Response Scale. The user may employ the Notes textbox, for example, to document thoughts regarding observable characteristics on the employee's performance relative to that particular skill, competency, or objective.

After selecting an Importance Weight for all items, the clicks on Save Assessment hyperlink 101 before leaving each screen or the data entered will not be saved. The present embodiment uses a Score Response Scale of 1 to 9 to determine the frequency (score) that the leader observes the individual demonstrating the stated characteristics for shared competencies, job specific skills and supplemental skills. With such scale, the upper end of the scale (7, 8 or 9) indicates the characteristic is exceptional. The middle (4, 5 or 6) indicates the characteristic is complete. The lower end of the scale (1, 2 or 3) indicates the characteristic is limited.

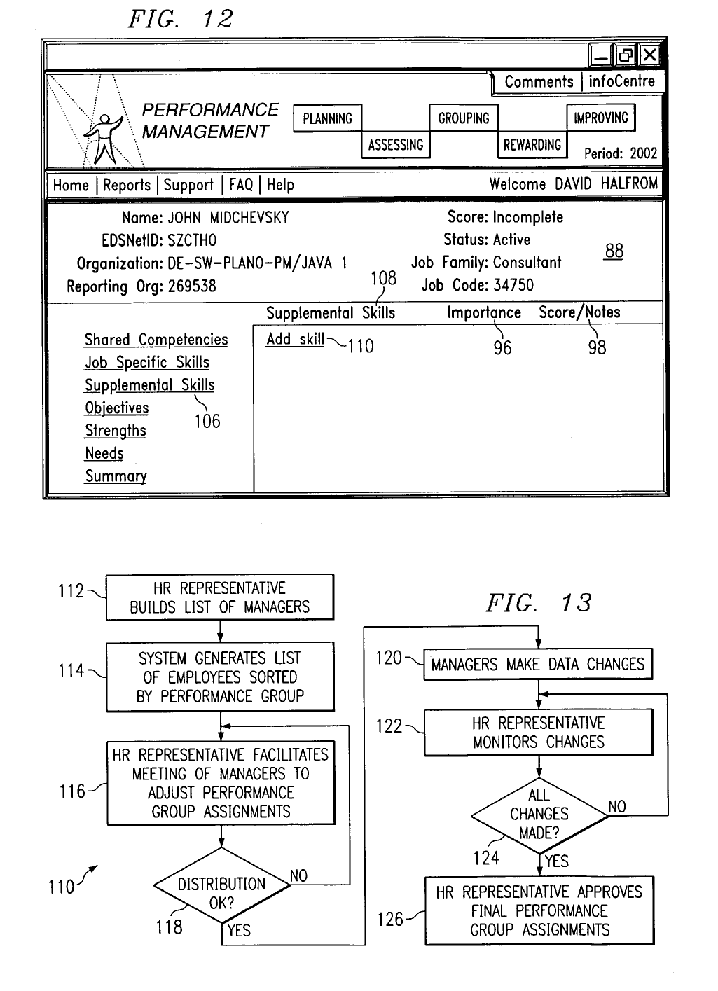

FIG. 11 shows another view of Individual Assessments Screen 88 relating to job specific skills as provided by the present invention. After providing input in Individual Assessments Screen 88, the user may select Job Specific Skills hyperlink 102 that will provide additional information including Job Specific Skills list 104 together with Importance listing 96 and Score/Notes listing 98. Note that in the listing of FIG. 11, the same Importance listing 96 and Score/Notes listing 98 is provided. However, these listings and selection blocks now relate to Job Specific Skills listing 104. Thus, in the example of FIG. 11, for the job specific skill “knowledge of technology systems and methods,” the importance value of 5 has been designated in importance block 96, and again there has been no score provided in this particular instance as shown by the “NS” value in scores/notes 98.

Note that in the present embodiment, when first assessing an employee with a leader job code, “Manager Competencies” link will be displayed under Job Specific Skills. Clicking on this link will open a window displaying Management Competencies and a notice directing the leader to read these before continuing. The Job Specific skills will then be displayed followed by the Manager Competencies link for future reference.

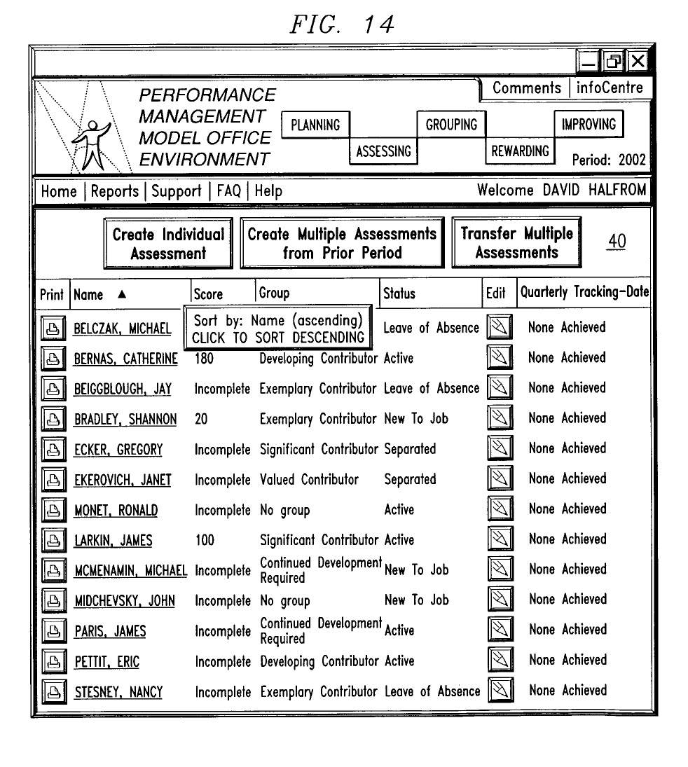

FIG. 12 shows how the present embodiment permits reporting on supplemental skills that an employee may possess as related to Individual Assessments Screen 88 using Supplemental Skills hyperlink 106. Supplemental skills are those an individual performs in addition to what is listed in their job description. This could include unique skills needed for special projects or assignments. Upon selecting Supplemental Skills hyperlink 106, supplemental skills listing 108 is provided. The supplemental skills view of Individual Assessments Screen 88 is used to enter any supplemental skills being evaluated. For leaders, these may be skills specific to their role, since their job specific skills are pre-populated with the management competencies. Once entered, the skill will appear on the list of supplemental skills. Add an importance weighting for each supplemental skill before allocating a score. A supplemental skill is a user-defined job specific skill. It uses the definition of a job specific skill, but the Assessing Manager provides content.

FIG. 13 illustrates one example of the process of grouping, which is an important practice of the process of the present invention. Grouping process 110 of the present invention enables the use of measurements and assessments that have been described relative to FIGS. 2-12 above and assist in the overall evaluation of the employee's performance. The process, according to the present embodiment, may be accomplished at the human resource representative level and includes the inputs from the numerous leaders or managers for which the human resource manager may generate an overall level of performance for individuals. This grouping of individuals is useful for the purpose of creating a standard of performance of different individuals and ensuring that those individuals' performance is properly assessed as well as planned for future task in optimizing their contribution to the company.

Thus, in FIG. 13, grouping process 110 may begin with the step of the HR representative building a list of managers from which a grouping effort will be undertaken, such as at block 112. The managers would relate to the individual performance group for which the grouping will be conducted. As a result, the performance management system of the present invention will generate from the list of managers or leaders for the individual employees at block 114, a list of all employees for that particular performance group based on the manager or leader list derived at step 112. Next, at block 116, the HR representative could facilitate a meeting of the managers or leaders to adjust the performance group's assignments to make sure that the grouping not only is appropriate based on the employees associated with the particular manager, but also to receive the approval of the individual leaders.

Moving to query 118, if the distribution is satisfactory, as determined by the leaders, managers and the HR representative, then the process flow proceeds to step 120 where managers or leaders are permitted to make appropriate data changes to the records for the grouping effort. On the other hand, if the distribution were not okay or satisfactory, the process would flow back to block 116 for further meetings until the distribution is satisfactory and the managers can then respond to the grouping by making any appropriate data changes.

After making data changes, as block 120 indicates, the HR representative is able to review and monitor changes to make sure that they are consistent with the objectives of the program and the process flow goes to query 124 to verify that all changes have been made to all appropriate records. If changes have not been made, then of course, the process flow would return to block 122 until the changes have in fact been made. After all changes have been made, as tested at query 128, the process flow then ends at block 126 where the HR representative would approve the final performance group assignment.

Still another way to view the grouping process may be as follows: Prior to a grouping session, the leader could complete a template, which may take any form consistent with the general teachings of the present invention, for assessing employee capability and performance. During such time the leader may examine employees within each grouping category to inform the employee of the rank the employee has attained. In the grouping process, individual leaders may assess their employees and place them in a preliminary grouping, based on their performance relative to the overall group in which they are placed. The business lead will send electronic messages, for example, to the human resources representative that could, for example, includes a list of all the leaders participating in the grouping session, as well as the day, time, and location of the grouping session. The human resources representative may then use the performance assessment tool of the present invention to create a merged list of all the leaders' employees and their preliminary groupings. This merged list will be exported to a password protected spreadsheet file and will be sent to the business lead for use in the grouping session. Files may be password protected and maintained securely to ensure data privacy.

To the extent practical, the business lead ensures all the leaders in the room can see the merged list and any subsequent changes. To the extent practical, the business lead confirms all remote managers (if any) are connected to the merged list and discussion via appropriate secure technology. As grouping discussions progress to the proper distribution, the human resources representative will make the necessary changes to the employee groupings in real-time. The grouping session is complete and final when the proper distribution has been met. Such a distribution may be when there is an upper 10%, followed by a second 15%, a middle 50%, a lower 15%, and a bottom 10% of employees.

If the proper forced distribution is not met, the business lead may ensure that a contingent decision representing the proper forced distribution is made during the grouping session. The business lead must seek approval from the leader or his designee for the proposed variance. If approval is not granted, the contingent decision representing the proper forced distribution will stand as the final decision.

The business lead may then send the final password protected merged list to the human resources representative. The business lead sends a modified version of the spreadsheet file to each of his leaders. This modified version preferably only includes that leader's respective employees. All leaders make the necessary changes to their preliminary lists in the performance assessment tool of the present invention based on the final merged list (spreadsheet file) within the time frame specified in the grouping session. Leaders will share the overall results of the employee performance management system and process of the present invention, including their groupings, with employees after company leadership notifies leaders to do so.

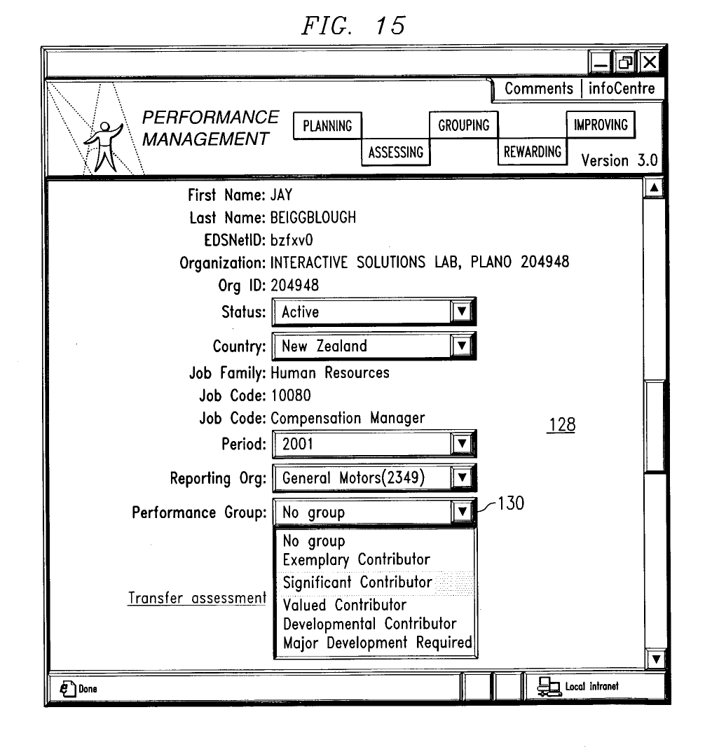

FIG. 14 provides a listing of grouped assessments as they might appear to a user of the present invention as a list of names that have been grouped in association with the user or assessment in Assessments Screen 40. In essence, Assessments Screen 40 of FIG. 14 shows the results of the process described in association with FIG. 13. The tentative score is displayed in association with each named employee in Assessments Screen 40. The score appearing is tentative and for reference only. It does not indicate whether or not the assessment is complete.

An assessment, in one embodiment, for example, may not be considered complete until after 80% of the Job Specific Skills and Shared Competencies are scored and 100% of the Objectives and Supplemental Skills are completed. A numerical score will then be displayed on the Assessment List screen next to the name of the employee. If an assessment is not completely scored, then the Assessment List screen will display “Incomplete” in place of a numeric score next to the name of the employee.

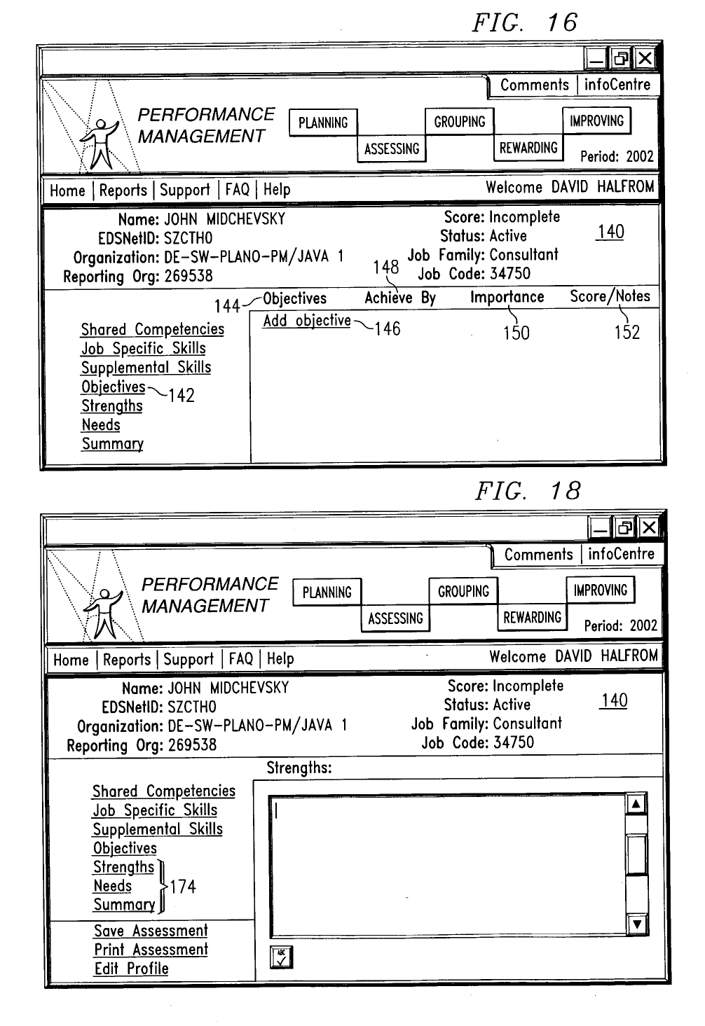

FIG. 15 further illustrates the template-driven tool of the present invention for making employee performance assessment groupings, wherein through Grouping screen 128 the individual records may be selected through for grouping purposes. In particular, upon electing, for example, in screen of FIG. 14, the name “BEIGGBLOUGH, JAY,” the user is directed via the associated hyperlink to Grouping screen 128, which includes the previously identified dropdown menus including the performance group dropdown menu 130. On performance group dropdown window menu 130, the user, usually the HR representative, may select for the individual the designation of “exemplary contributor,” “significant contributor,” “valued contributor,” “developmental contributor,” or “major development required.” This would provide for the individual the designation of his grouping for management and other purposes.

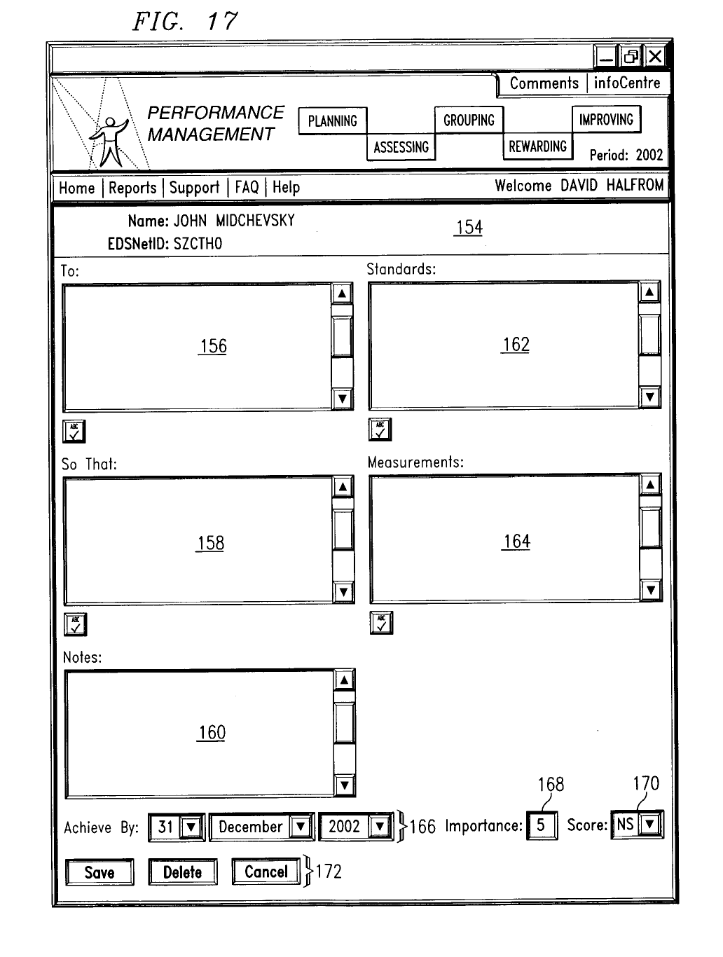

FIG. 16 depicts one embodiment of how the present invention may permit the stating of objectives relating to employee performance. In FIG. 16, the performance management program moves to the functions of planning as indicated earlier in block 16 of FIG. 1. Through the development steps of working with the two-way communication between the employee and the leader, the concepts for objectives, both business objectives and learning objectives, are identified.

For this purpose, FIG. 16 shows screen 140 to illustrate how the present invention could help establish objectives and support of the individual employee's performance plan. Thus, by selecting Objectives hyperlink 142, Objectives listing 144 appears and includes “Add objective” hyperlink 146 which upon being selected, the user is taken to an objective development space which is described in more detail in FIG. 17 below. In addition, Objectives screen 140 provides “Achieve by” listing 148 which details the date by which the listed objective in objectives listing 144 is to be achieved. Importance listing 150 provides a measure of importance much like that provided above with regard to individual skills, but this importance relates to the importance of the individual objective. Furthermore, Score/Notes listing 152 provides the ability to indicate a score as well as provides for notes relating to a particular objective again functionally similar to the Score/Notes listing 98 of prior screen 88.

The present invention therefore permits the user to document business objectives and learning objectives for an upcoming assessment period. Business objectives may be viewed as what the employer needs to accomplish to drive business and/or client results organizational effectiveness). Learning objectives relate to new skills, knowledge, and the like that will support the employee's further career development.

Objectives should reflect what employees are being held accountable for during the calendar year. Business objectives should align with the team, organization, business plans, and objectives. In the present invention, objectives are entered manually. A minimum of three objectives and a maximum of ten objectives are preferred. For optional use of the present invention, objectives should not be written at the transaction level, but should contain an element of stretch. They should not be easy and should provide enough challenge so that extra effort is required to achieve the objective. Objectives can extend beyond or begin before the performance period. In this case, the present invention permits the leader to assess employees on a quarterly basis to review objectives listed, standards, and expected overall progress. Once entered, add importance weights for each objective before scoring.

For the score response scale in the objective Section, use the upper end of the scale (7, 8 or 9) if the objective has been surpassed. Use the middle of the scale (4, 5 or 6) if the objective has been achieved. Use the lower end of the scale (1, 2 or 3) if the objective has not been met. Use the space following each item to write a brief (1 or 2 sentence) justification for your assessment.

A principal part of focusing on organizational goals includes setting objectives. Objectives direct individual jobs to grow in the direction of the business need. Objectives clarify performance expectations by defining specific goals to be accomplished in a given performance cycle. Two primary types of objectives include business objectives and learning objectives. Business objectives address what is needed to drive business and/or client results, i.e., objectives focusing or organizational effectiveness. Learning objectives, on the other hand, address what is needed to improve on the job, i.e., objectives focusing or individual effectiveness.

When setting objectives, considering certain criteria has value. Effective objectives are: specific, measurable, attainable, relevant and challenging, and time bound. A specific objective defines what is to be done by when. It should encourage better performance than a vaguely defined one. Each objective should include a specific “measurement of success,” enabling the employee and his leader to determine the extent to which the objective has been achieved. A measurable objective generally defines factors such as quantity, cost, timeliness, and/or quality, as applicable. Employees should set objectives that are reasonably within the employee's area of influence and authority to achieve. Objectives need to be relevant to the job and focused on adding value to the organization. Achieving proper balance between “attainable” and “challenging” requires analysis of the work needs and environment, along with the employee's job duties, skills, abilities, and performance levels. Finally, an effective objective has an established and specific deadline.

FIG. 17 details still further an embodiment of how the present invention may take the above concepts to create the objectives function to permit development of business and learning objectives. The program of the present invention takes the user to objectives screen 154 upon the user's selection of objective hyperlink 146 of FIG. 16. Thus, for the individual JOHN MIDCHEVSKY example of FIG. 17, a number of windows appear to present specifying the characteristics of a particular objective. This includes the “To” window 156 that permits a textural statement of what the objective may be for the individual. “So that” window 158 provides a space whereby the individual may state the purpose of the particular objective. “Note” window 160 makes it possible for the user to add any particular notes of interest relative to the objective. Moreover, “Standards” window 162 permits the ability to show how to state how the particular objective will be measured or compared to a particular objective relative to other standards within the organization.

“Measurements” window 164 makes it possible to specify particular measurements relating to a particular objective. Furthermore, in “Objectives” window 154, pull down menus 166 make it possible to specify the date by which the objective shall be obtained. Importance field 168 provides the ability to input an importance weighting or value for the particular objective, whereas score block 170 makes it possible to provide a particular score relative to the objective. Also in objectives screen 154 are control buttons 172 permitting the user to, respectively, save, delete, and cancel the particular input for the objective. Associated with the planning with the objective screen 140 are the hyperlinks 174 to permit the user to identify certain strengths and needs of the user, as well as to obtain a summary of the particular performance plan for the individual.

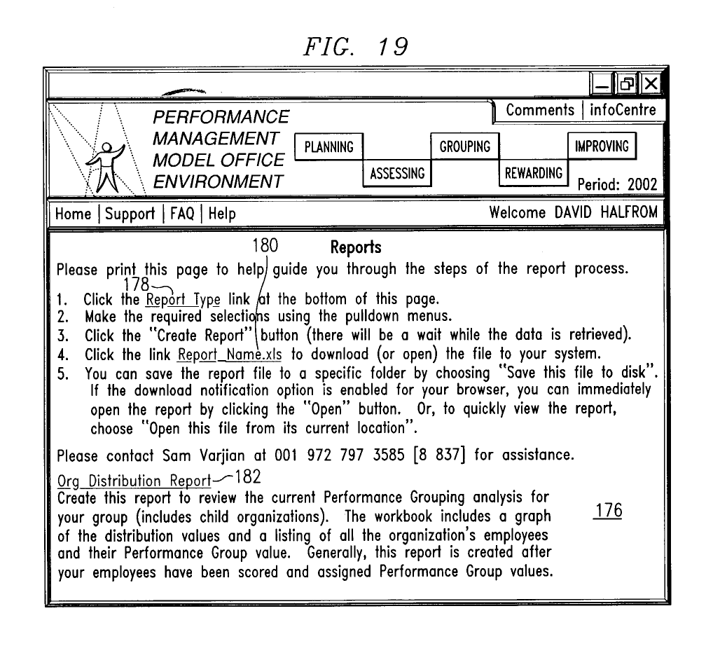

FIG. 18 exhibits further the aspect of the present embodiment for assessing employee performance strengths and needs, as well as providing a summary of the employee performance assessment. This screen is used to document the employee's strengths and development needs, including a narrative describing the overall performance for the assessment period. On the Summary screen, the peer-team-customer (PTC) tool or MS Word template may be used to solicit feedback from the employee's peers, team members or customers. This information will be helpful for the employee when completing an individual development plan.

The system provides, in one embodiment, the ability to control the direct transfer of original PTC data into assessments. This helps to ensure that the leader is always a ‘filter’ for the data. One benefit of this feature could be that by controlling the direct transfer, the manager may paraphrase or edit the original data and, thereby, prevent unfiltered data (that could be offensive or counterproductive) from reaching an employee.

FIG. 19 shows the capability of the preferred embodiment for generating reports of employee performance by showing Reports screen 176 of the present invention that provides the ability to review and generate different types of reports of employee performance assessments. From report screen 176 hyperlinks such as reports type hyperlink 178 and Report_Name.xls hyperlink 180 permit navigation to different types of reports and different documents that are useful for the purpose of communicating in other permanent media the results that the employee performance management system of the present invention generates. In addition, from Reports screen 176 it is possible to generate an organizational distribution report using Org Distribution Report hyperlink 182 for the creation of a report indicating the distribution values and a listing of employees according to the performance group values.

This functionality allows the printing of each employee's performance summary to keep as a hard copy for leader's files and quick reference. Two versions are available to the leader, “Employee Copy” and “Leader Copy”. The Leader Copy version contains the same content as the Employee Copy with the addition of all Note fields. The next screen displays the Performance Summary for review before printing.

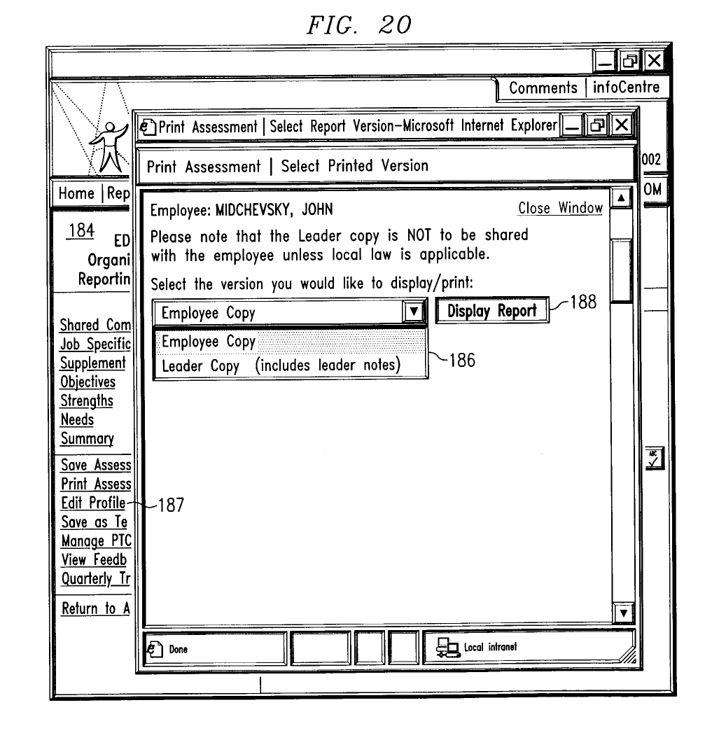

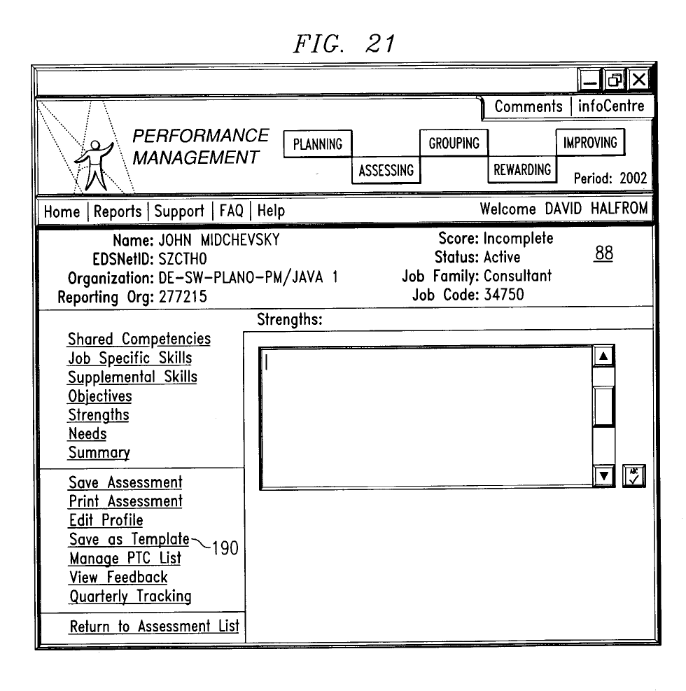

FIG. 20 shows one instance of the different selections for employee performance assessment reports obtainable through assessment print screen 184 whereby the employee, in shown example JOHN MIDCHEVSKY, may generate a leader copy of the employee report. For example, using Report Version dropdown window 186, JOHN MIDCHEVSKY may generate an employee copy or a leader copy that may include certain employee notes respecting JOHN MIDCHEVSKY. By clicking Display Report button 188, such a report is generated. The report may be a PDF document or a Word document. Such a report may take many forms. However, what is important for purposes of the present invention is that the report would include the different shared competencies, importance and scores or notes, as well as similar information regarding job specific skills, supplemental skills, objectives, strengths, needs and other information.

Edit Profile hyperlink 187 may give the option to change pertinent information regarding the employee, including deleting or transferring an employee's assessment. The edit profile screen displays an employee's data profile and allows for transferring this file when an employee moves to another leader. This is also where the employee's preliminary grouping level is entered and can be changed, if necessary, after the grouping session.

When an assessing manager changes the job code for an existing assessment, the shared competencies and job specific skills for the assessment could be replaced with new skills from the application, set to default values. Supplemental skills objectives, and other assessment data could, in such case, be preserved. Job Titles/Codes and their Job Families may be searched by clicking on the “Lookup Job Title/Code” button, entering the beginning numbers of a Job Code, clicking the “Search” button, and then clicking on the correct Job Code from the search results.

FIG. 21 gives one view of the present invention's ability to save different templates of employee performance assessments for future use. FIG. 21, for example, shows individual assessment screen 88 again to highlight the Save As Template function 190. This permits the user to include the previously generated information for a variety of purposes, such as creating new assessments on the same employee or different employees who may have similar job requirements or have similar competencies and skills. The ability to save as a template such information can significantly increase the speed and consistency of different reports relative to individual employees.

The template function may be used when assessing employees in the same job code. This will save time by populating objectives and weights for each skill, competency and objective tied to that job code. Once the first assessment has been created, it may be saved as a template to use for others in that job code and duties.

Viewing a list of Templates may also be considered a function of the present invention. In order to view a list of existing templates, the user clicks on the “My Templates” hyperlink from the Home screen (see FIG. 2). The “My Templates” hyperlink will only appear if the user has either created his own template(s) or one has been transferred to him.

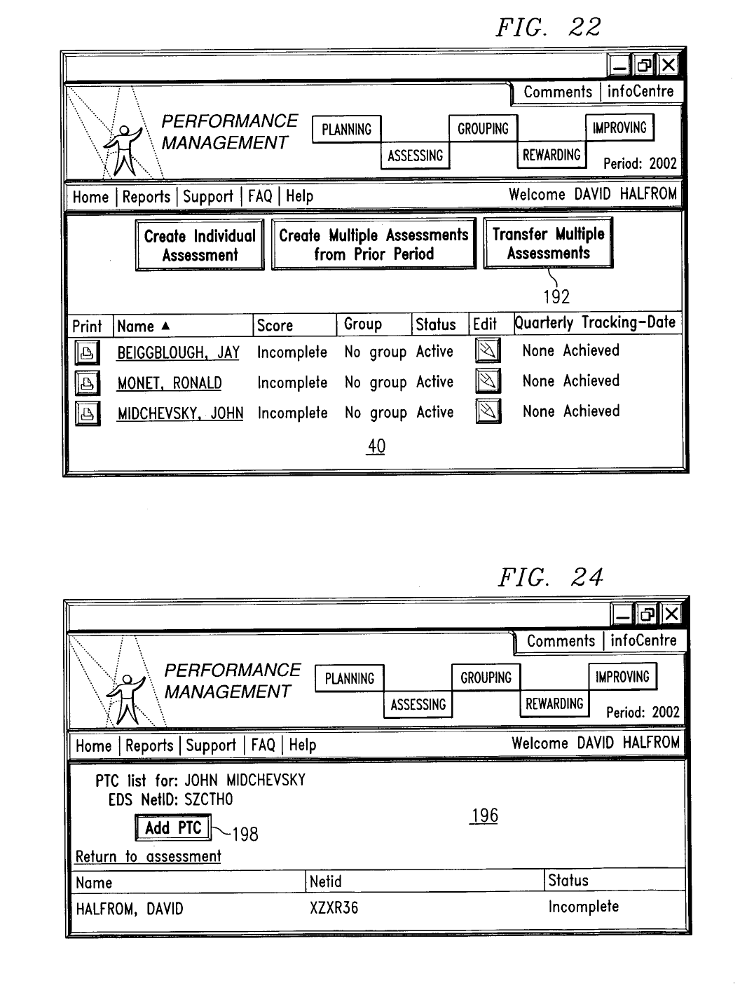

FIG. 22 shows the multiple assessment transfer features of the present invention as assessment screen 40 to illustrate possible the functions of transfer of multiple assessments button 192. From within an assessment, click on “Edit Profile” and then “Transfer Assessment” to search for the manager's name to whom you will transfer the employee's assessment history. Click on the appropriate gaining leader from the search results as shown below.

Assessments can be transferred from either the Assessment screen 40 (one or more assessments at a time) or from within an individual assessment screen 88. The complete performance history (existing assessments from all periods) for the employee is transferred.

From Assessment Screen 40, the user clicks on the “Transfer Multiple Assessments” button 192. An Assessments Transfer screen will list the existing assessments. The user will then click the check box next to the assessments to be transferred, and then the “Transfer Selected Assessments” button. The next step is to search for the manager's name you will transfer the assessments.

Once the gaining leader is located, click “Transfer Assessment”. The assessment will then transfer to the gaining leader, where the gaining leader will then be able to view it using the system of the present invention. The transferred assessment will no longer appear in the original leader's list of assessments.

FIGS. 23 through 25 illustrate the further feature of the present invention for managing peer-team-customer employee performance assessments. FIG. 23 shows Individual Assessments Screen 88. This time, however, attention goes to the Manage PTC List hyperlink 194. This hyperlink, upon selection, permits the user to manage the peer-team-customer list for those individuals for whom such reviews may be sought. Upon selecting Manage PTC List hyperlink 194, the employee performance program of the present invention provides the option of directing the user to PTC List Screen 196.

View Feedback hyperlink 195 allows viewing the PTC feedback for an employee in order to create that employee's Summary section. This screen displays all PTC feedback collected for a specific employee's performance. If at least three individuals provided feedback, there will be an average score for each PTC feedback statement, with additional information regarding the relationship of each surveyed and the strengths and needs perceived by the multi-raters. If there were fewer than three raters, “NS” or Not Scored will be shown for the employee on his/her PTC feedback statements. It is not appropriate for managers to just “copy and paste” the PTC feedback in the Performance Summary section. The purpose of the PTC feedback is for managers to have input to help them give better feedback to the employee. Generally, the PTC tool for entering PTC feedback should be available during third and fourth quarter.

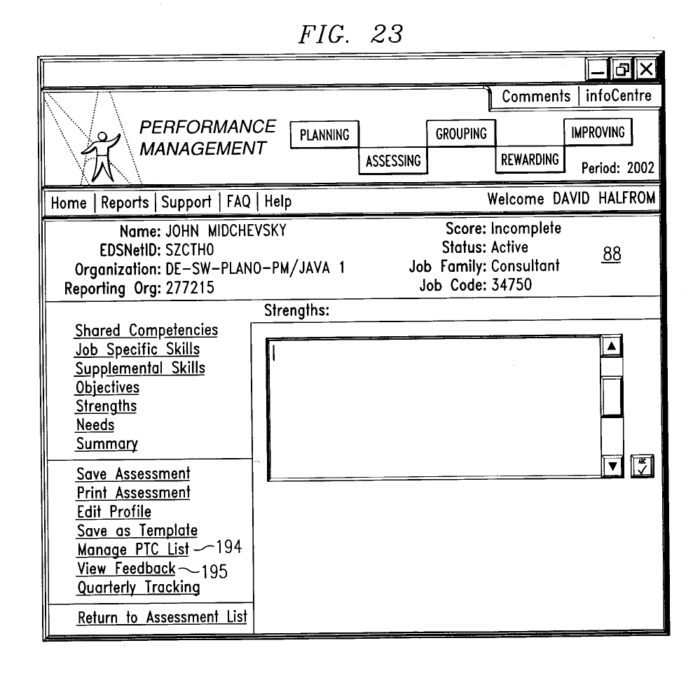

PTC List Screen 196 of FIG. 24 provides to the user a listing of an individual employee, in this instance JOHN MIDCHEVSKY, for whom the peer-team-customer input may be requested. By clicking on Add PTC button 198, the user is permitted to add to the list of PTC inputs or peer-team-customer inputs for providing more assessments regarding the individual, e.g., JOHN MIDCHEVSKY. Thus, upon adding to the PTC Review list, the user, in this instance, DAVID HALFROM, is being requested to provide information on certain employees.

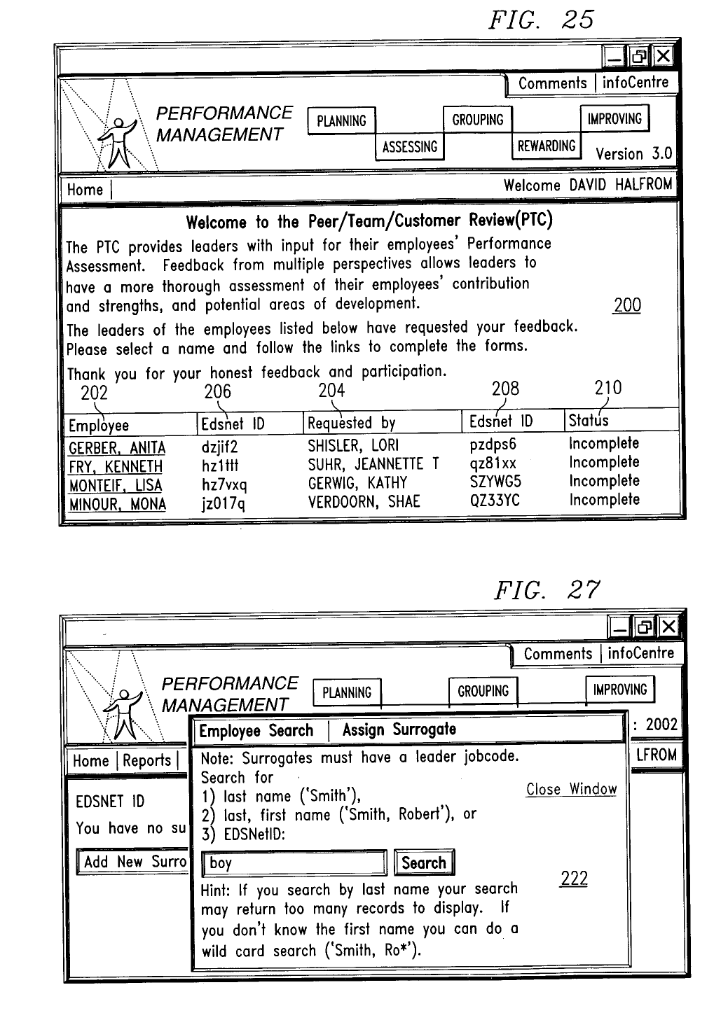

On PTC Review screen 200 of FIG. 25, the list of employees 202 includes the names “GERBER, ANITA,” “FRY, KENNETH,” “MONTEIF, LISA,” and “MINOUR, MONA.” The Requested by column 204 indicates by whom the PTC review is being requested of the user DAVID HALFROM. In addition, the employee identifiers column 206 identifies the individual employees for whom PTC reviews are requested while employee ID column 208 identifies the identification numbers relating to the individuals by whom the PTC review is being requested. Furthermore, column 210 shows the status of the different PTC reviews that the persons listed in the Requested by column 204 have sought. The Manage PTC List screen allows you to invite employees to fill out PTC forms for each assessment as well as to view and manage a listing of the invited employees.

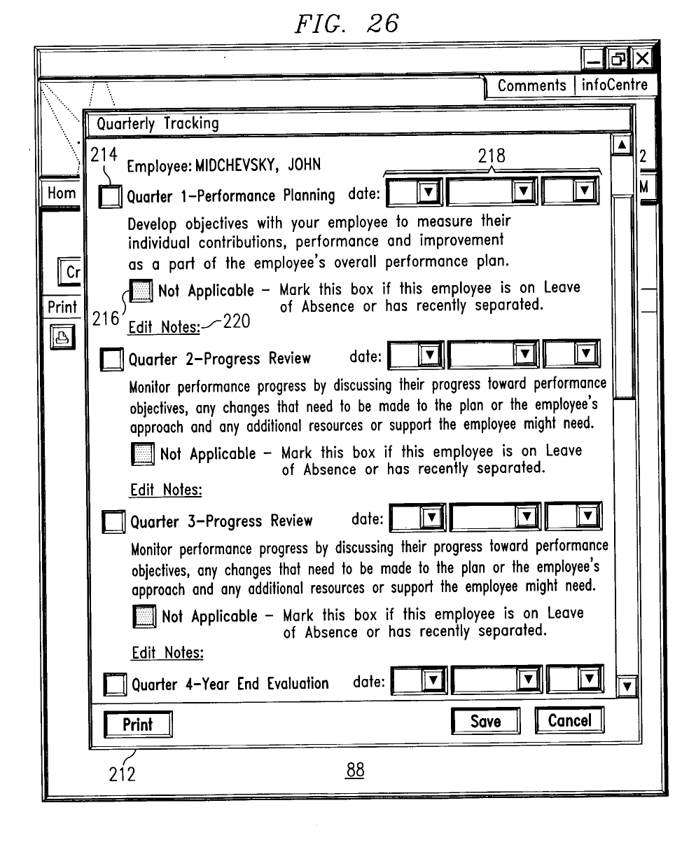

FIG. 26 illustrates Quarterly Tracking screen 212 of the present invention that may be accessible through the Individual Assessments Screen 88. As Quarterly Tracking template 212 indicates for the example of employee JOHN MIDCHEVSKY, four quarters relate to the assessment of his performance. This includes Quarter 1 in which performance planning is to take place, Quarter 2 where progress is reviewed, Quarter 3 where another progress review is to occur and finally Quarter 4 where year-end evaluations take place. The function of Quarterly Tracking template 212 is to provide a mechanism for the scheduling and completion of each quarterly function relating to the employee performance management. For example, referencing Quarter 1, check box 214 permits the user to check to indicate that the quarterly performance planning has in fact been done or by check box 216 indicate that such is not necessary. In association with the Quarter 1 performance planning, date boxes 218 provide the ability to schedule and discern the completion of the performance planning. Moreover, hyperlink 220 permits the user to include any notes that might relate to the completion of Quarter 1 performance planning steps. Such would be the case further with regard to Quarters 2 and 3 for progress review, and finally for the year-end evaluations in quarter 4.

FIG. 27 shows another feature of the employee performance management system of the present invention that would include the ability to search for different surrogates. Referring for a moment to FIG. 3, note that the “My Surrogate” hyperlink 38 allows the user to designate and manage the use of surrogates. Thus, in FIG. 27, the Surrogate search template 222 permits the user to search for different surrogates that might be associated with the individual. Such surrogates have the different functions, such as, for example, being able to report on different individuals for the leader or manger who designates the surrogate.

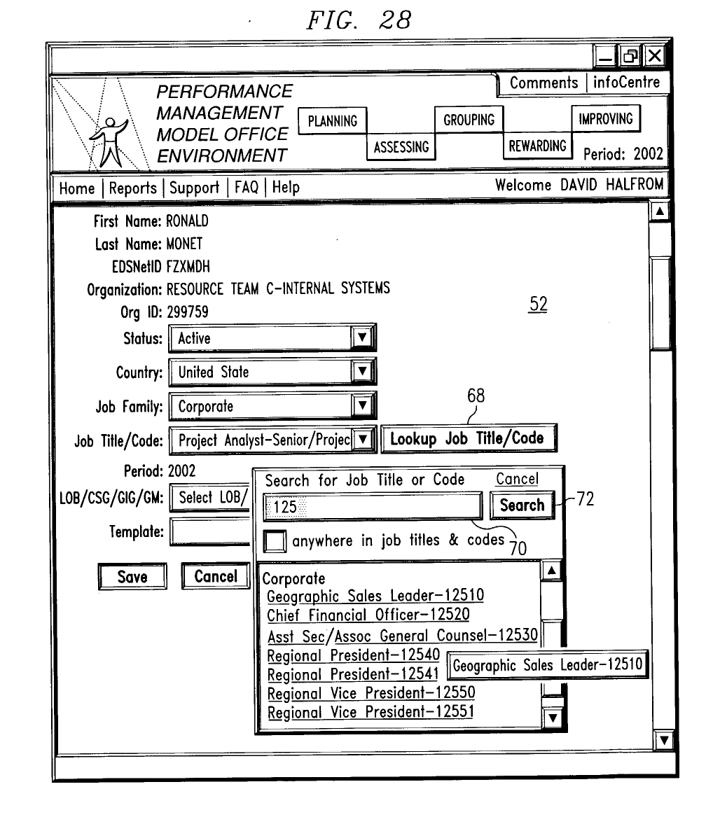

FIG. 28 shows yet another function of the present invention through Assessment Creation Screen 52. That is, with the present invention, it is possible to identify the different types of jobs that a company may have with regard to using a template such as Job Title or Code template through the use of look up job title code button 68 that allows the user to input in Job Title or Code window 70 a job title or code and, upon clicking Search button 72, is given the information relating to the different corporate job titles or codes that relate to the term specified in search window 70. The results of this activity, therefore, will be that the user will be aware of different jobs and different opportunities that exist within the company.

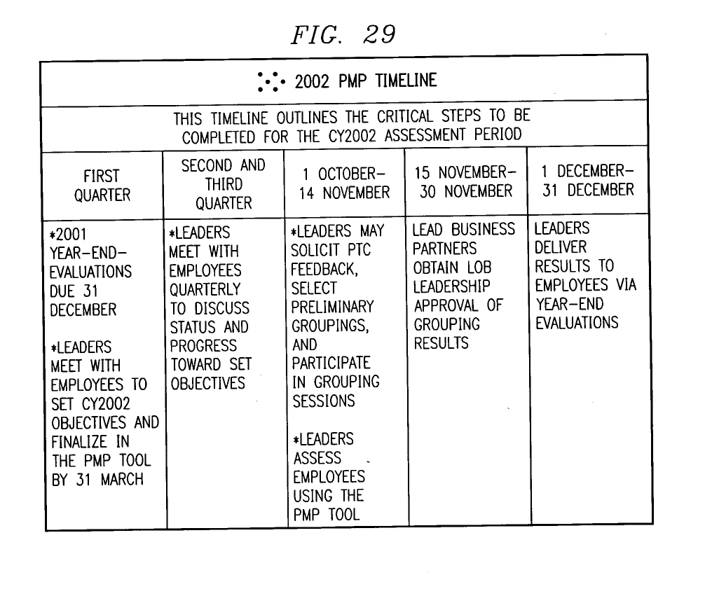

FIG. 29 provides a table outlining the steps to be completed for a typical calendar in implementing the improved employee performance management system of the present invention. The methods and system of present invention are divided into three phases of activity that occur throughout the year. In the performance-planning phase, the first phase leaders will develop or clarify organization and team goals. The employee can help prepare objectives to measure his contributions, performance, and improvement as part of your overall performance plan.

In the progress review phase, the second phase leaders monitor performance progress and have regular discussions with the employee about his performance. Discussions of the progress and status of current year objectives take place with each employee during the second calendar quarter. Feedback on strengths and development needs can be identified here. Employee may also be coached on any setbacks regarding objectives. To this end, the present invention includes the process and instructions to develop a prescriptive path or course adjustment to advise the employee regarding behavior and performance improvements.

The second phase of the present invention includes progress reviews and discussion. Process discussions are a vital, ongoing part of this program. These discussions should be structured to enable the employee and leader to share feedback on performance objectives. After the performance plan is developed, the employee and his leader are jointly responsible for ensuring that periodic discussions and progress reviews occur.

Leaders continue to generally monitor employee performance and progress during the process review and discussion phase. Progress discussions should be structured to enable the leader and the employee to share feedback on performance objectives and allow the leader to contribute to the employee's overall development. After the performance plan is developed, the leader and the employee are jointly responsible for ensuring that periodic discussions and progress reviews occur.

Leaders should have ongoing discussions with employees about their performance. Remember to document progress and what was discussed. These discussions are an important part of the employee performance management process and system of the present invention because such discussions provide an opportunity to discuss progress toward performance objectives, any changes that need to be made to the plan or to the employee's approach, as well as any additional resources or support the employee might need.

The present invention assists leaders to act as effective coaches. By improving the evaluation of employee performance, the present invention aids the employee to achieve his objectives through appropriate support and guidance throughout the performance cycle. In doing so, the leader may become a mentor and facilitator—not just a “manager.” Coaching can occur throughout the performance cycle.

Feedback is information about performance that is communicated to improve performance or develop the employee. Regular feedback can be a powerful tool for helping the employee achieve performance goals. The present invention provides a means for communicating to the employee differences between the communicated performance status and a performance standard associated with the employee. The present invention makes it possible to provide feedback, and ask others for feedback, throughout the entire performance cycle. As employees work toward their objectives, the present invention makes it possible to let them know which behaviors to continue, discontinue, or modify.

The third phase entails employee assessment, differentiation process, and communications regarding year-end performance evaluations. During this last phase, leaders may request input from employees, peers, team members and/or internal customers about the employee's performance, assess the employee using the system of the present invention; participate in the grouping process, and discuss the employee's accomplishments, contributions, and targeted areas for improvement. In addition, leaders will inform the employee of his performance grouping level during your individual year-end evaluation.

In using the employee performance management method and system of the present invention, current, year-end evaluations may be processed by December. Also, during this period, objectives for the next year will be discussed. The employee and leader will enter at least three to ten business and learning objectives in the employee performance management system for each employee by the end of the first calendar quarter. Employees are also encouraged to create an individual development plan.

The present invention includes steps and supporting instructions for performance planning, which is the critical first phase of the process. Successful performance planning provides a foundation for the entire process. During this phase (which, for example, may occur during the first quarter of the calendar year), the employee's leader should help the employee develop a personal performance plan that includes (1) organization goals, (2) team goals, (3) key job responsibilities, (4) tracking sources to enable the employee and his leader to track the employee's progress towards goals and objectives during the year. The employee also preferably will prepare or update an individual development plan for career development purposes.

The third phase of the present invention entails assessment, differentiation process, and year-end performance evaluation communications. During this phase (which generally occurs during the fourth quarter of each calendar year), the leader completes the three-phase process by gathering feedback on an employee to complete the employee's assessment, grouping the employee in grouping sessions, and communicating to the employee in the year-end evaluations the employee's grouping level.

In the assessment process, the leader may monitor and discuss the employee progress through the year, and may prepare for an employee's year-end evaluation using a peer-team-customer review process. The peer-team-customer collects input from an employee's colleagues, both to assess performance and to provide constructive feedback. Such a review normally draws on constructive feedback from approximately five-seven of an employee's peers, team members and/or internal customers.

With the present invention, feedback may be submitted using the two peer-team-customer review options, including a web-based tool or the word processing document template. The next phase in the employee performance management process and system of the present invention involves the use of a performance management template.

The third phase may also include a differential process for applying corporate guidelines to each organization's business circumstances and needs. In this process, the company may define and implement the grouping strategy (for example, specifics of group size, and monitoring of the grouping process) for the appropriate level of employees. This may be specified such as group size and how the group process may be monitored.

The third phase still further may include grouping sessions at which leaders will assign and consolidate grouping levels based on corporate guidelines. The grouping level results for each group will be monitored and are expected to yield five designated distribution percentages. These may be the groupings of, for example, 10% exemplary contributors; 15% significant contributors; 50% valued contributors; 15% developing contributors; and 10% continued development required. Once approved at the appropriate management level, the employee's leader notifies the employee of his grouping during his year-end evaluation.

Completing the third phase of the present process may also entail beginning to prepare for the next year's performance cycle. The completed year-end evaluations will be a valuable tool for the next cycle as they provide good working drafts for assessing and updating goals, objectives, and skills. Also, the outcomes can help identify areas for continued learning and development for the next performance cycle. Progress and evaluation discussions can help identify special interests, new challenges, and opportunities for partnering with others.

The phase for the performance management program process and system of the present invention are the same as for the first cycle; the success of the new plan begins again with first phase performance planning.

Preferably, during the third calendar quarter, the process and system of the present invention include discussions of progress and status of 2002 objectives with employees. This is also an appropriate time to collect peer, team customer feedback on each employee, if applicable, as well as to give feedback on strengths and development needs. During this time, the leader coaches his employees on any setbacks regarding objectives, as well as support employee's success toward set objectives.

Fourth calendar quarter activities may include assessing employees using the system of the present invention. The fourth calendar quarter is also an appropriate period in which to complete the grouping process and designate grouping in the system of the present invention. After groupings are finalized, the leader may discuss year-end evaluation with each employee during this period. The quarterly tracking function of the present invention may also be used for each employee to profile them after each quarterly discussion. The present invention also permits the user to add notes concerning specific objectives, competencies or skills regarding observable behavior.

Accordingly, it is to be understood that the embodiments of the invention herein described are merely illustrative of the application of the principles of the invention. Reference herein to details of the illustrated embodiments are not intended to limit the scope of the claims, which themselves recite those features regarded as essential to the invention.

We claim:

1. A method for managing organization personnel through automated performance documentation, comprising the steps of:
a. generating a template-based evaluation record for documenting personnel performance over defined intervals of a performance evaluation period;
b. generating a template-based future performance plan with reference to said template-based evaluation record, said template-based future performance plan comprising a plurality of objectives relating to personnel performance standards;
c. reviewing personnel performance at approximately the end of said defined intervals referring to said template-based future performance plan; and
d. repeating steps a. through c.; above, through successive performance evaluation periods referring to any existing prior ones of said template-based evaluation records and said template-based future performance plans.

2. The method of claim 1, further comprising the step of drawing personnel data for completing said template-based evaluation record from a pre-existing corporate directory service.

3. The method of claim 2, wherein said pre-existing corporate directory service comprises instructions written in a first computer language and said template-based evaluation record comprises instructions written in a second computer language, and further wherein said first computer language differs from said second computer language.

4. A method for managing organizational personnel though a single integrated interface using automated performance documentation, comprising the steps of:
generating a template-based evaluation records comprising a predetermined set of evaluation records for documenting personnel performance over defined intervals of a performance period, wherein each of said predetermine set of evaluation records relates to a subset of individuals of said organizational personnel
generating a template-based future performance plan with reference to any existing prior ones of said predetermined set of evaluation records for said a subset of individuals, said template-based future performance plan comprising a plurality of objectives relating to personnel performance standards; and
reviewing at approximately the end of said defined intervals of said performance period the progress of selected ones of said at least a subset of individuals referring to said template-based future performance plan.

5. A method for generating a template-based evaluation record for managing the performance of an individual within the personnel of an organization, comprising the steps of: generating an evaluation record comprising the individual, said evaluation record comprising initially the individual name, organization and identification designation, organization, and location data;
assessing the performance of said subset of individuals using a template-based menu for assessing competencies and skills of said individuals.

6. The method of claim 5, further comprising the step of erecting an individual performance plan for said subject of said individuals using a template-based menu of objectives.

7. The method of claim 6, wherein said objectives derive from a template-based menu of business objectives.

8. The method of claim 6, wherein said objectives derive from a template-based menu of learning objectives.

9. The method of claim 5, further comprising the step of assessing the performance of said subset of individuals according to observed performance strengths of said subset of individuals.

10. The method of claim 5, further comprising the step of saving said evaluation record as a template for future use in generating additional evaluation records.

11. The method of claim 5, further comprising the step of soliciting assessment information from peers of the individual within the organization.

12. The method of claim 5, further comprising the step of soliciting assessment information from customers of the individual from outside the organization.

13. The method of claim 5, further comprising the step of soliciting assessment information from team members of teams within which the individual has performed.

14. The method of claim 5, further comprising the step of tracking the progress of the individual with reference to said individual performance plan at defined intervals within performance evaluation period.

15. The method of claim 5, wherein said competencies further comprise a set of shared competencies drawn from a template-based menu of shared competencies.

16. The method of claim 5, wherein said skills further comprise a set of job specific skills drawn from a template-based menu of job specific skills.

17. The method of claim 16, wherein said job specific skills associate with predetermined job codes relating to predetermined jobs within the organization.

18. The method of claim 5, wherein said skills further comprise a set of supplemental skills benefiting the individual's job performance.

19. The method of claim 1, further comprising the step of grouping the performances a subset of individuals of the personnel of an organization according to a predetermined set of criteria.

20. The method of claim 19, further comprising the step of recommending compensation adjustments for each of a subset of individuals within the organization personnel according to the grouping of said subset of individuals.

21. The method of claim 5, further comprising the step of generating a template-based report of said evaluation record.

22. The method of claim 6, further comprising the step of transferring within the organization a subset of evaluation record relating to said subset of individuals.

23. The method of claim 5, further comprising the step of searching for a named individual according to the existing of an associated evaluation record.

24. The method of claim 16, further comprising the step of searching for job code standards according to a job code database associated with the personnel of the organization.

25. A performance management method for identifying, differentiating, and rewarding performance of an employee, comprising the steps of:
communicating performance status to the employee;
communicating to the employee differences between the communicated performance status and a performance standard associated with the employee; and
developing a prescriptive path for the employee to adjust the communicated performance status in response to said performance standard.

26. A system for managing organization personnel through automated performance documentation, comprising instructions for:
a. generating a template-based evaluation record for documenting personnel performance over defined intervals of a performance evaluation period;
b. generating a template-based future performance plan with reference to said template-based evaluation record, said template-based future performance plan comprising a plurality of objectives relating to personnel performance standards;
c. reviewing personnel performance at at approximately the end of said defined intervals referring to said template-based future performance plan; and
d. repeating steps a. through c., above, through successive performance evaluation periods referring to any existing prior ones of said template-based evaluation records and said template-based future performance plans.

27. The system of claim 26, further comprising instructions for drawing personnel data from a corporate directory for completing said template-based evaluation record from a pre-existing corporate directory service.

28. The system of claim 27, wherein said pre-existing corporate directory service comprises instructions written in a first computer language and said template-based evaluation record comprises instructions written in a second computer language, and further wherein said first computer language differs from said second computer language.

29. A system for managing organizational personnel though a single integrated interface using automated performance documentation, comprising instructions for:
generating a template-based evaluation records comprising a predetermined set of evaluation records for documenting personnel performance over defined intervals of a performance period, wherein each of said predetermine set of evaluation records relates to a subset of individuals of said organizational personnel
generating a template-based future performance plan with reference to any existing prior ones of said predetermined set of evaluation records for said a subset of individuals, said template-based future performance plan comprising a plurality of objectives relating to personnel performance standards; and
reviewing at approximately the end of said defined intervals of said performance period the progress of selected ones of said a subset of individuals referring to said template-based future performance plan.

30. A system for generating a template-based evaluation record for managing the performance of an individual within the personnel of an organization, comprising instructions for: generating an evaluation record comprising the individual, said evaluation record comprising initially the individual name, organization and identification designation, organization, and location data;
assessing the performance of said subset of individuals using a template-based menu for assessing competencies and skills of said individuals.

31. The system of claim 30, further comprising instructions for erecting an individual performance plan for said subject of said individuals using a template-based menu of objectives.

32. The system of claim 31, wherein said objectives derive from a template-based menu of business objectives.

33. The system of claim 31, wherein said objectives derive from a template-based menu of learning objectives.

34. The system of claim 30, further comprising instructions for assessing the performance of said subset of individuals according to observed performance strengths of said subset of individuals.

35. The system of claim 30, further comprising instructions for saving said evaluation record as a template for future use in generating additional evaluation records.

36. The system of claim 30, further comprising instructions for soliciting assessment information from peers of the individual within the organization.

37. The system of claim 30, further comprising instructions for soliciting assessment information from customers of the individual from outside the organization.

38. The system of claim 30, further comprising instructions for soliciting assessment information from team members of teams within which the individual has performed.

39. The system of claim 30, further comprising instructions for tracking the progress of the individual with reference to said individual performance plan at defined intervals within performance evaluation period.

40. The system of claim 30, wherein said competencies further comprise a set of shared competencies drawn from a template-based menu of shared competencies.

41. The system of claim 30, wherein said skills further comprise a set of job specific skills drawn from a template-based menu of job specific skills.

42. The system of claim 27, wherein said job specific skills associate with predetermined job codes relating to predetermined jobs within the organization.

43. The system of claim 30, wherein said skills further comprise a set of supplemental skills benefiting the individual's job performance.

44. The system of claim 27, further comprising instructions for grouping the performances a subset of individuals of the personnel of an organization according to a predetermined set of criteria.

45. The system of claim 27, further comprising instructions for recommending compensation adjustments for each of a subset of individuals within the organization personnel according to the grouping of said subset of individuals.
